(19) United States
(12) Patent Application Publication
(10) Pub. No.: US 2017/0306585 A1
(43) Pub. Date: Oct. 26, 2017

(54) Pivot system with adjustable height to actuate a door latch for an excavator bucket

(71) Applicant: Minetec S.A., Santiago (CL)

(72) Inventors: Claudio Zamorano Jones, Santiago (CL); Bernardo Vera Torres, Santiago (CL); Jean Pierre Vidal Piesset, Santiago (CL)

(21) Appl. No.: 15/496,445

(22) Filed: Apr. 25, 2017

(30) Foreign Application Priority Data
Apr. 25, 2016 (CL) 0983-2016

(51) Int. Cl. E02F 3/407; E05B 65/00; E02F 3/40

(52) U.S. Cl. CPC E02F 3/4075; E02F 3/401; E05B 65/00

(57) ABSTRACT

Embodiments of the invention relate generally to earth movement machine components and, more particularly, to a pivot system with adjustable height to actuate a door latch for an excavator bucket.

### CROSS-REFERENCE TO RELATED APPLICATIONS

This application claims the benefit of co-pending Chilean Patent Application No. CL 0983-2016, filed 25 Apr. 2016, which is hereby incorporated herein as though fully set forth.

### TECHNICAL FIELD

Embodiments of the invention relate to the field of earth movement machine components and refer specifically to a pivot system with adjustable height to actuate a door latch for an excavator bucket.

### DESCRIPTION OF THE PRIOR ART

The latch for excavator machine shovel buckets meets the function of locking the door of the shovel bucket prior to beginning loading in order to prevent the cargo from falling out once material has entered the bucket and keeps it secure during transport done by the excavator to the unloading place. At the moment of unloading, the door unlocks to allow the material to be released in the unloading place, by activating the latch. It can therefore be deduced from the above that this element locks and unlocks many times during the work of loading and unloading an excavator's bucket.

Activation of the latch is made by a mechanical system. This system consists of a lever mechanism comprising an arm which is supported in an articulated manner on the bucket's structure by one end and the other end is attached to a cable by which the arm is raised when activated by the operator. The mechanism lifts the latch which is also attached in an articulated manner to an area near the articulated end of the arm, exerting a lever multiplier effect with respect to the force applied by the mechanism activated by the operator on the cable, which lifts the latch and allow the door to unlock to release the material. The arm end in its articulated portion is mounted on a box support, which is in turn mounted on a set of shims that allow the adjustment of said arm's height, since repeated use causes wear on the latch tip. This prevents the latch from being trapped in the eye of the latch, which would cause the latch lifting mechanism to erroneously or inadequately lock the door.

In the prior art, the set of shims is secured to the bucket structure by using a rod which secures the entire set of shims to said structure, as shown in FIG. 2a. The area in which the arm end that lifts or lowers the latch that secures the door to the bucket body and where the shims are pivots is usually called pivot box (1), the shims are located on the front of the pivot box (1) causing said shims (5) to bend by their own weight the fastening rod (7) in the area of its mounting hole (6) when the door (2) is parallel to the ground surface (P), as shown in FIG. 2b, particularly during transport of cargo when shims exert, as indicated in the arrows in FIGS. 2a and 2b, a bending stress on the rod due to gravity in the direction of said arrows. Furthermore, it is difficult to remove the rod and difficulties are generated in height adjustment in the pivot box, and shims can possibly fall, disabling the operation of the latch mechanism.

The proposed use model changes the position and the manner to secure the shims inside the pivot box, avoiding the above problems.

### SUMMARY OF THE INVENTION

A pivot system with an arm's adjustable height to actuate a door's latch for an excavator bucket which compensates for wear on the latch, where the location of shims is changed to the side of the pivot box and an upper trap is implemented which is welded to the door structure, providing an increased rigidity to a rod for fastening shims and preventing its movement due to a securing mechanism, preventing shims from falling out, the shims with this new distribution are supported by the beams at their sides, becoming trapped and not exerting any force on the rod. The rod can optionally be secured by a cotter pin or using a bolted lock.

### BRIEF DESCRIPTION OF THE FIGURES

FIG. 1 shows an isometric view of the location of the pivot box on a door and the latch lifting elements.

FIG. 2a shows an isometric view of the latch and the pivot box with the location of the shims and the rod according to the state of the art.

FIG. 2b shows the bucket when the door is parallel to the ground surface during transport of the cargo.

FIG. 3 shows an isometric view of the changes made in the position and the manner for securing the shims.

FIG. 4 shows a side view of the changes made in the position and the manner for securing the shims.

FIG. 5 shows a pivot box support.

FIG. 6 shows an exploded view with the main component parts of the latch actuation system and contained in the pivot box.

FIG. 7a shows the fastening of the shims' securing rod using a cotter pin lock.

FIG. 7b shows the fastening of the shims' securing rod using a bolted lock.

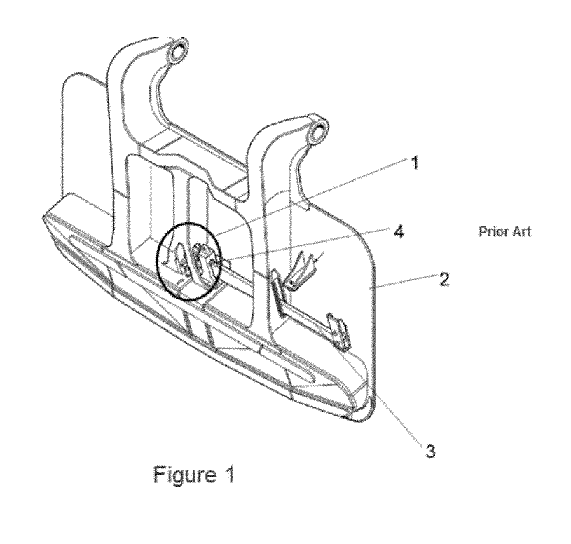

### DETAILED DESCRIPTION OF THE INVENTION

During actuation for unlocking the door (2) of the backhoe bucket, an arm (3) is lifted and lowered from its end (13) by a cable controlled by a mechanism activated by the operator, the arm (3) is attached in an articulated manner by its other end through a mounting hole (12) to the axis (10) of a box support (9) located inside a pivot box (1). A set of shims (5) is located in the base (11) of the box support (9), said shims are secured to the structure (14) of the door (2) by a rod (7) passing through mounting holes (6) of the shims (5) and subsequently fastening slidably to the structure (14) of the door (2) through a hole (18) for such purpose.

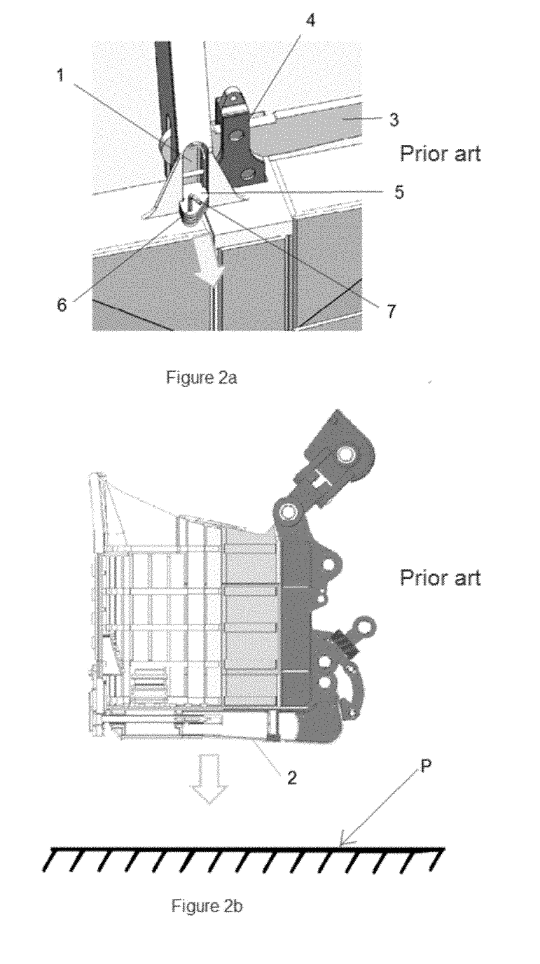

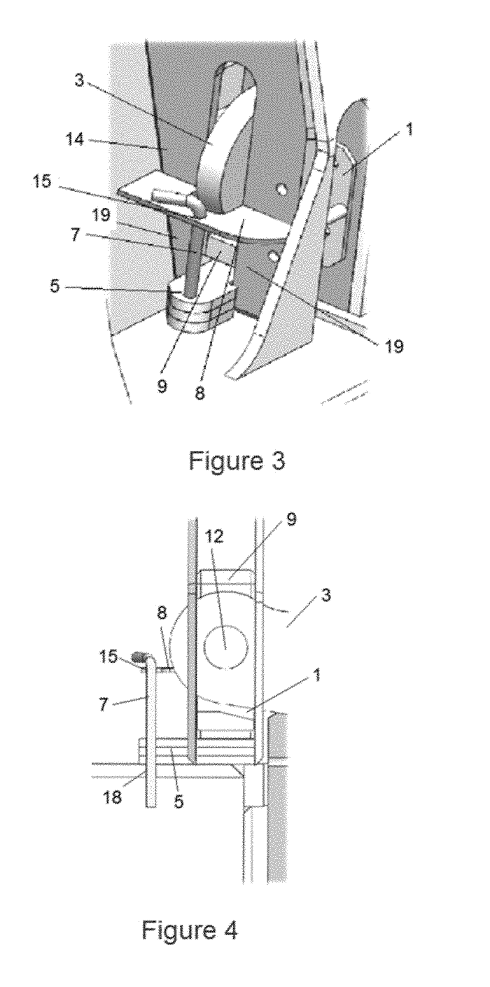

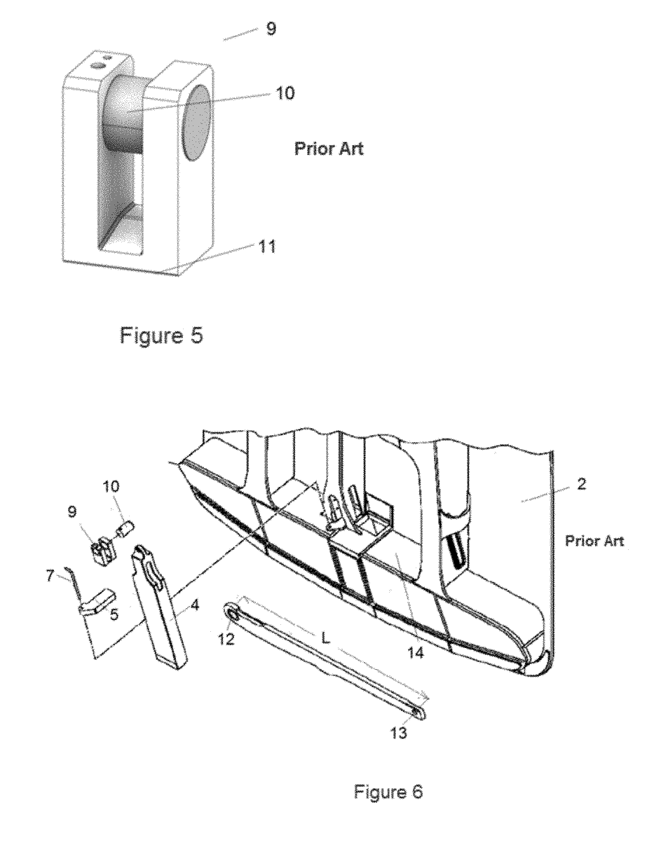

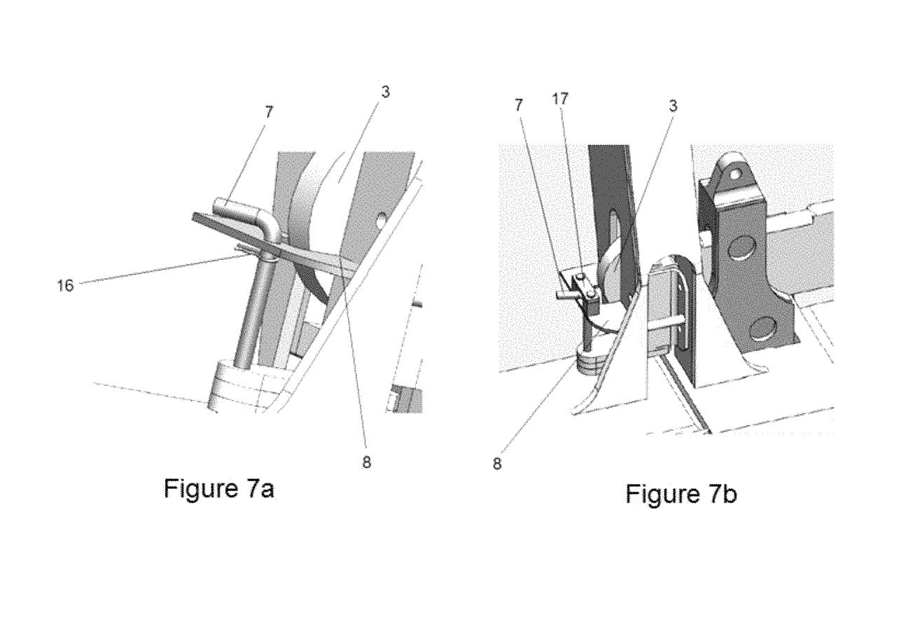

The proposed solution is displayed in FIGS. 3 and 4 wherein an upper trap (8) is implemented which is welded to two beams (19) forming a part of the structure of the door (14) providing an increased rigidity to the rod (7) and preventing its movement by preventing shims (5) from falling out. Furthermore, the location of the shims (5) is changed to the side of the pivot box (1), said shims (5) becoming parallel to the arm's length (L) and not perpendicular to said length (L) as described above for the state of the art, where it is transverse to the direction of gravity as shown by the arrows in FIGS. 2a and 2b, this causes the weight of the shims (5) not to affect or bend the rod (7). Furthermore, the shims (5) with this new distribution are supported by beams (19) on their sides, becoming trapped and not exerting any force on the rod (7). As shown in FIG. 7a, the rod can be optionally secured by a cotter pin lock (18) or, as shown in FIG. 7b, by a bolted lock (17).

What is claimed is:

1. A pivot system with an adjustable height of an arm for actuating a latch of a door for an excavator bucket which compensates for wear on the latch, the pivot system comprising:
an arm articulated by a box support comprising an axis where an end of said arm pivots with a hole;
a box support which regulates a height of said arm by using interchangeable shims located at a base of the box support;
a mounting rod used for the shims, which goes through the shims by holes in each shim, and wherein the rod also goes through from side to side of the structure of the excavator bucket door through a hole for this purpose, preventing the mounting rod from bending due to use and pressure of the shims and also preventing the shims from falling out by disabling operation of the latch mechanism,
wherein:
the pivot system has an upper trap comprising a metal plate welded to a structure of the door with a borehole where a trap is located directly on the shims perpendicular to the arm's length, through which the mounting rod goes through a borehole prior to going through the shims and through the structure of the door;
the shims are located parallel to the arm's length passing below the base of the box support;
in operation, the shims become trapped between two beams.

2. A pivot system with adjustable height according to claim 1 wherein the rod can be secured by a cotter pin lock.

3. A pivot system with adjustable height according to claim 1 wherein the rod can be secured by a bolted lock.
